(19) United States
(12) Patent Application Publication
(10) Pub. No.: US 2004/0080141 A1
(43) Pub. Date: Apr. 29, 2004

(54) Interchangeable socket hitch and security bar for trailer hitch assembly

(76) Inventor: Robert B. Hart, Front Royal, VA (US)

Correspondence Address: Dodds & Associates, 1707 N Street NW, Washington, DC, 20036, US

(21) Appl. No.: 10/065,549

(22) Filed: Oct. 29, 2002

(51) Int. Cl. B60D 1/00

(52) U.S. Cl. 280/507

(57) ABSTRACT

Trailer hitch and security system employing interchangeable coupling hitch and security plug that can be locked in a receiver tube rigidly coupled to the trailer.

### BACKGROUND OF INVENTION

1. Field of the Invention

The present invention relates generally to systems for coupling trailers to towing vehicles. In another aspect, the invention relates to systems for preventing theft of trailers that are decoupled from towing vehicles.

2. Description of the Prior Art

Many different configurations of hitch systems are known in the art for allowing a trailer to be readily coupled to and decoupled from a towing vehicle. One common configuration for attaching a trailer to a vehicle is by using a standard hitch ball attached to the rear of the vehicle and a socket hitch attached to the yoke of the trailer. During towing of the trailer, the socket hitch receives the hitch ball and couples the trailer to the vehicle. When the trailer is decoupled from the vehicle, the socket hitch is exposed and can be readily coupled to another vehicle.

One problem with prior art systems of coupling trailers to vehicles is that once the trailer is decoupled from a vehicle, it is easy for another vehicle to hook up to the trailer and steal it. This problem is especially significant when a heavy trailer carrying expensive equipment is required on a remote job site (e.g., a construction site). Due to the added expense and danger involved in towing a heavy trailer to a remote job site, it is highly undesirable to continually transport a heavy trailer back and forth between the job site and a secure home location on a daily basis. However, it can also be highly undesirable to store a trailer carrying expensive equipment at a remote job site due to the risk of theft of the trailer.

### SUMMARY OF INVENTION

Responsive to these and other problems, it is an object of the present invention to provide an inexpensive and easy-to-use trailer hitch and security system that prevents theft of a trailer that is detached from a towing vehicle. Further objects and advantages of the invention will be apparent from the drawings, detailed description of the preferred embodiment, and appended claims.

Accordingly, in one embodiment of the present invention there is provided a hitch and security system for a trailer. The system generally comprises a receiver tube, a coupling hitch, a security plug, and an elongated locking pin. The receiver tube is rigidly coupled to the trailer and defines a receiver channel extending inwardly from the distal end of the receiver tube. The coupling hitch includes a coupler adapted to be releasably coupled to a vehicle and an elongated hitch bar adapted to be releasably and snugly received in the receiver channel. The security plug includes a security bar adapted to be releasably and snugly received in the receiver channel. The system is shiftable between a towing position wherein the coupling hitch is coupled to the receiver tube by the locking pin and a secured position wherein the security plug is coupled to the receiver tube by the locking pin.

In another embodiment of the present invention, there is provided an apparatus comprising a trailer, a coupling hitch, a security plug, and a key-actuated locking pin. The trailer includes a receiver tube defining a receiver channel that extends inwardly from a distal end of the receiver tube. The receiver tube defines a pair of substantially aligned receiver holes positioned on opposite sides of the receiver tube. The receiver holes are spaced a first distance from the distal end of the receiver tube. The coupling hitch includes a socket hitch defining a tow ball-receiving socket and an elongated hitch bar adapted to be releasably and snugly received in the receiver channel. The hitch bar defines a hitch opening extending entirely through the hitch bar. The coupling hitch presents a protruding lip proximate the hitch bar. The hitch opening is spaced a second distance from the lip. The security plug includes a security bar adapted to be releasably and snugly received in the receiver channel and a protruding flange proximate one end of the security bar. The security bar defines a plug opening extending entirely through the security bar. The plug opening is spaced a third distance from the flange. The key-actuated locking pin includes a generally cylindrical main body presenting first and second ends. The locking pin includes a fixed collar rigidly coupled to the first end of the main body and a releasable collar adapted to be releasably coupled to the second end of the main body. The main body of the locking pin is configured to be slidably and releasably received in the receiver holes, the hitch opening, and the plug opening. The first, second, and third distances are substantially equal.

In a further embodiment of the present invention, there is provided a method of securing a trailer. The method comprises the steps of: (a) removing a coupling hitch from a receiver tube of the trailer; (b) inserting a security plug into the receiver tube; (c) extending a locking pin through the receiver tube and the security plug, thereby securing the security plug in the receiver tube; and (d) locking the locking pin in the receiver tube and the security plug so unauthorized removal of the locking pin from the receiver tube and security plug is prevented.

### BRIEF DESCRIPTION OF DRAWINGS

A preferred embodiment of the present invention is described in detail below with reference to the attached drawing figures, wherein:

FIG. 1 is a partial isometric view of a trailer having a hitch and security system constructed in accordance with the principles of the present invention, particularly illustrating the system in a secured position with a security plug being received in a receiver tube of the trailer and a locking pin being in a locked position to thereby secure the security plug in the receiver tube;

FIG. 2 is an enlarged isometric assembly view of the hitch and security system, particularly illustrating the manner in which a coupling hitch and the security plug can be interchangeably received and locked in the receiver tube;

FIG. 3 is a partial sectional view of the hitch and security system, particularly illustrating the system in a secured position with the security plug being received in the receiver tube and locked therein with the locking pin;

FIG. 4 is a bottom view of the underside of the trailer prior to being modified with the inventive security system; and

FIG. 5 is a bottom view of the underside of the trailer after being modified to include the inventive security system.

### DETAILED DESCRIPTION

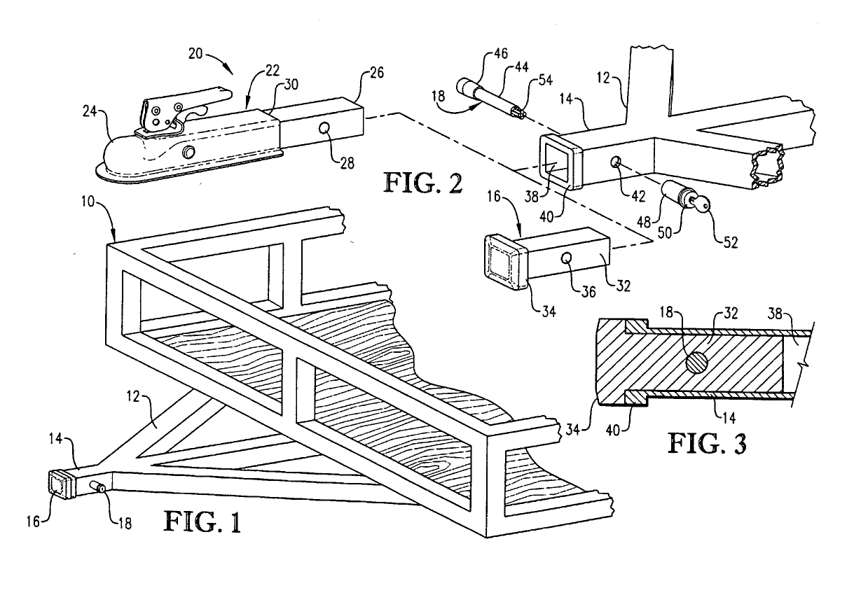

Referring initially to FIG. 1, the front portion of a trailer 10 is illustrated as including a yoke 12 and a receiver tube 14 rigidly coupled to yoke 12. Trailer 10 can be originally manufactured to include receiver tube 14 or can be modified to include receiver tube 14. Methods of modifying trailer 10 to include receiver tube 14 are discussed in detail below with respect to FIGS. 4 and 5. FIG. 1 shows a security plug 16 being received in receiver tube 14 and locked in receiver tube 14 via locking pin 18. In such a configuration, it is virtually impossible to couple trailer 10 to a towing vehicle using any conventional means. Thus, FIG. 1 shows trailer 10 in a secured configuration where unauthorized towing of trailer 10 is prevented.

Referring to FIG. 2, a hitch and security system 20 is illustrated as generally comprising a coupling hitch 22, security plug 16, receiver tube 14, and locking pin 18.

Coupling hitch 22 includes a coupler 24 and a hitch bar 26. Coupler 24 can be any commercially available mechanism operable to releasably couple a trailer to a standard towing element on a vehicle. Preferably, coupler 24 is a standard socket hitch used to couple the trailer to a standard towing ball on a vehicle. Hitch bar 26 is preferably a substantially solid metal bar having a generally rectangular cross section. It is preferred for hitch bar 26 to extend at least about four inches from coupler 24. Most preferably, hitch bar 26 extends in the range of from about five to about ten inches from coupler 24. Hitch bar 26 defines a hitch opening 28 extending entirely through hitch bar 26. Preferably, coupling hitch 22 presents a protruding lip 30 proximate the junction of hitch bar 26 and coupler 24. It is preferred for hitch bar 26 to extend into and be welded to coupler 24. In order to ensure adequate strength of coupling hitch 22, the welds coupling hitch bar 26 to coupler 24 preferably are formed using at least two passes (i.e., a root pass and a cover pass). Further, after welding, a cooling grace period should be recognized in order to allow the welds to cool naturally (i.e., without quenching with water or forced air).

Security plug 16 includes a security bar 32 and a protruding flange 34. Security bar 32 is preferably a substantially solid metal bar having a generally rectangular cross section. It is preferred for the cross section of security bar 32 and hitch bar 26 to be substantially the same. Security bar 32 defines a plug opening 36 extending entirely through security bar 32. Flange 34 is rigidly coupled to security bar 32 proximate one end of security bar 32.

Receiver tube 14 is rigidly coupled to yoke 12 and defines a receiver channel 38 extending into receiver tube 14 from a distal end 40 of receiver tube 14. Receiver channel 38 is preferably a rectangular channel that is dimensioned to slidably and snugly receive either hitch bar 26 or security plug 16. Receiver tube 14 defines receiver holes 42 that extend through the walls of receiver tube 14 on generally opposite sides of receiver tube 14.

Locking pin 18 generally includes a substantially cylindrical main body 44, a fixed collar 46 rigidly attached to one end of main body 44, and a removable collar 48 adapted to be releasably coupled to a distal end 54 of main body 44. Main body 44 preferably has a generally circular cross section that is configured to be extendable through and snugly received in receiver holes 42, hitch opening 28, and plug opening 36. Removable collar 48 preferably includes a locking mechanism 50 that is actuatable via a key 52. Locking mechanism 50 preferably includes an externally threaded male element that can be threaded into female threads defined in an opening in distal end 54 of main body 44 when key 52 is received in locking mechanism 50 and locking mechanism 50 and main body 44 are rotated relative to one another. When key 52 is removed from locking mechanism 50, locking mechanism 50 and main body 44 cannot be rotated relative to one another. Thus, locking pin 18 is shiftable between an unlocked position wherein removable collar 48 is decoupled from main body 44 and a locked position wherein removable collar 48 is coupled to main body 44 via threading of locking mechanism 50 into distal end 54 of main body 44. In order to shift locking pin 18 into or out of the locked position, key 52 must be received in locking mechanism 50, thereby preventing unauthorized unlocking of locking pin 18. A variety of locking pins suitable for use in the present invention are commercially available. For example, one suitable locking pin is sold under the commercial designation of “Dead-Bolt Receiver Lock, PN 7862,” available from Draw-Tite, Inc., Canton, Mich.

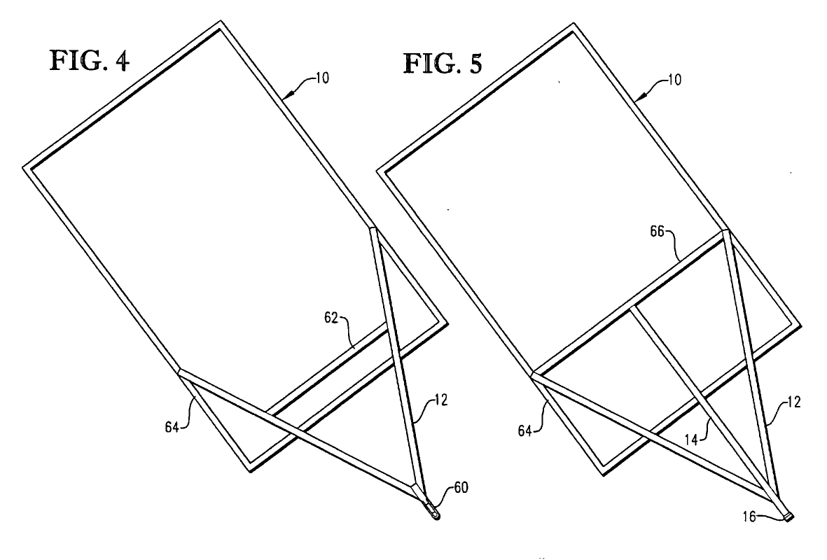

Referring again to FIG. 2, hitch and security system 20 can be shifted between a towing position and a secured position. When hitch and security system 20 is in the towing position, hitch bar 26 is received in receiver channel 38, lip 30 engages distal end 40, locking pin 18 extends through receiver holes 42 and hitch opening 28, and locking pin 18 is in the locked position. When hitch and security system 20 is in the secured position (also shown in FIG. 3), security bar 32 is received in receiver channel 38, flange 34 engages distal end 40, locking pin 18 extends through receiver holes 42 and plug opening 36, and locking pin 18 is in the locked position.

Referring now to FIGS. 1-3, in operation, when hitch and security system 20 is in the towing position, described above, trailer 10 can be towed by a vehicle via coupling of the vehicle to coupler 24. When trailer 10 has been transported to its desired destination, hitch and security system 20 can be shifted into the secured position by shifting locking pin 18 from the locked position to the unlocked position, removing locking pin 18 from receiver holes 42 and hitch opening 28, sliding hitch bar 26 out of receiver channel 38, sliding security bar 32 into receiver channel 38 until flange 34 engages distal end 40, extending main body 44 of locking pin 18 through receiver holes 42 and plug opening 36, and shifting locking pin 18 from the unlocked position to the locked position. It should be noted that flange 34 is spaced from plug opening 32 a distance such that when flange 34 engages distal end 40, plug opening 36 is substantially aligned with receiver holes 42.

When hitch and security system 20 is in the secured position, security plug 16 and locking pin 18 prevent trailer 10 from being coupled to a vehicle by conventional means. When it is desired to once again transport trailer 10, hitch and security system 20 can be shifted from the secured position back to the towing position by shifting locking pin 18 from the locked position to the unlocked position, removing locking pin 18 from receiver holes 42 and plug opening 36, sliding security bar 32 out of receiver channel 38, sliding hitch bar 26 into receiver channel 38 until lip 30 engages distal end 40, extending main body 44 of locking pin 18 through receiver holes 42 and hitch opening 28, and shifting locking pin 18 from the unlocked position to the locked position. It should also be noted that lip 30 is spaced from hitch opening 28 a distance such that when lip 30 engages distal end 40, hitch opening 28 is substantially aligned with receiver holes 42. Thus, the distances between distal end 40 and receiver holes 42, lip 30 and hitch opening 28, and flange 34 and plug opening 36 are substantially the same to allow for easy alignment of hitch opening 28 and plug opening 36 with receiver holes 42.

Referring to FIGS. 4 and 5, the underside of trailer 10 is illustrated in order to show the manner in which a conventional trailer (shown in FIG. 4) can be modified to employ the present invention (see FIG. 5). Referring to FIG. 4, the first step in modifying trailer 10 is to remove a standard hitch 60 from yoke 12 and a standard cross-bar 62 from a frame 64 of trailer 10. This is typically done using a cutting torch. Referring to FIG. 5, trailer 10 can-then be equipped with the inventive security system by extending receiver tube 14 under trailer 10 at least one-fourth the length of trailer 14. A new cross-bar 66 can be extended across trailer 10 at the end of receiver tube 14 and welded to frame 64. Receiver tube 14 can then be welded to yoke 12, frame 64, and cross-bar 66 in accordance with the preferred welding procedures described earlier. Receiver tube 14 is preferably formed of high-strength seamless square tubing.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

1. A hitch and security system for a trailer that can be towed by a vehicle, said system comprising:
a receiver tube rigidly coupled to the trailer and defining a receiver channel extending inwardly from a distal end of the receiver tube;
a coupling hitch including a coupler adapted to be releasably coupled to the vehicle and an elongated hitch bar adapted to be releasably and snugly received in the receiver channel;
a security plug including a security bar adapted to be releasably and snugly received in the receiver channel; and
an elongated locking pin,
said system being shiftable between a towing position wherein the coupling hitch is coupled to the receiver tube by the locking pin and a secured position wherein the security plug is coupled to the receiver tube by the locking pin.

2. The system according to claim 1,
said hitch bar defining a hitch opening extending therethrough,
said security bar defining a plug opening extending therethrough,
said receiver tube defining a receiver hole,
said locking pin extending through the receiver hole and the hitch opening when the system is in the towing position,
said locking pin extending through the receiver hole and the plug opening when the system is in the secured position.

3. The system according to claim 2,
said security plug including a flange proximate one end of the security bar,
said flange engaging the distal end of the receiver tube when the system is in the secured position.

4. The system according to claim 3,
said coupling hitch including a lip proximate the junction of the hitch bar and the coupler,
lip engaging the distal end of the receiver tube when the system is in the towing position.

5. The system according to claim 2,
said locking pin comprising a generally cylindrical elongated main body presenting first and second ends,
said locking pin including a fixed collar rigidly coupled to the first end of the main body,
said locking pin including a removable collar releasably coupleable to the second end of the main body,
said locking pin being shiftable between a locked position wherein the removable collar is coupled to the main body and an unlocked position wherein the removable collar is decoupled from the main body,
said locking pin being in the locked position when the system is in the towing position and the secured position.

6. The system according to claim 5,
said locking collar threadably engaging the second end of the main body when the locking pin is in the locked position.

7. The system according to claim 5,
said locking collar including a key,
said locking collar including a key-activated locking mechanism that only allows the locking collar to be coupled or decoupled from the main body when the key is received in the locking mechanism.

8. An apparatus comprising:
a trailer including a receiver tube defining a receiver channel extending inwardly from a distal end of the receiver tube, said receiver tube defining a pair of substantially aligned receiver holes positioned on generally opposite ends of the receiver tube, said receiver holes being spaced a first distance from the distal end of the receiver tube;
a coupling hitch including a socket hitch defining a tow ball-receiving socket and an elongated hitch bar adapted to be releasably and snugly received in the receiver channel, said hitch bar defining a hitch opening extending entirely through the hitch bar, said coupling hitch presenting a protruding lip proximate the hitch bar, said hitch opening being spaced a second distance from the lip;
a security plug including a security bar adapted to be releasably and snugly received in the receiver channel and a protruding flange proximate the security bar, said security bar defining a plug opening extending entirely through the security bar, said plug opening being spaced a third distance from the flange; and
a key-actuated locking pin including a generally cylindrical main body presenting first and second ends, said locking pin including a fixed collar coupled to the first end and a releasable collar releasably coupleable to the second end, said main body being configured to be slidably and releasably received in the receiver holes, the hitch opening, and the plug opening, said first, second, and third distances being substantially equal.

9. The apparatus according to claim 8,
said apparatus being shiftable between a towing position wherein the locking pin extends through the receiver openings and the hitch opening and a secured position wherein the locking pin extends through the receiver holes and the plug opening.

10. The apparatus according to claim 9,
said locking pin being shiftable between a locked position wherein the removable collar is coupled to the main body and an unlocked position wherein the removable collar is decoupled from the main body,
said locking pin being in the locked position when the apparatus is in the towing position and the secured position.

11. A method of securing a trailer, said method comprising the steps of:
(a) removing a coupling hitch from a receiver tube of the trailer;
(b) inserting a security plug into the receiver tube;
(c) extending a locking pin through the receiver tube and the security plug thereby securing the security plug in the receiver tube; and
(d) locking the locking pin in the receiver tube and the security plug so that unauthorized removal of the locking pin from the receiver tube and the security plug is prevented.

12. The method according to claim 11,
step (a) including, removing the security pin from the receiver tube and the coupling hitch.

13. The method according to claim 12,
step (a) including, using a key to decouple a locking mechanism of the locking pin from a main body of the locking pin.

14. The method according to claim 13,
step (d) including, using the key to couple the locking mechanism of the locking pin to the main body of the locking pin.

15. The method according to claim 14; and
(e) prior to step (a), towing the trailer with a vehicle by coupling the coupling hitch to a standard towing element on the vehicle.

16. The method according to claim 11; and
(f) prior to step (a), modifying the trailer to include the receiver tube.

17. The method according to claim 16,
step (f) including removing a standard hitch from the trailer, extending the receiver tube under the trailer at least one-fourth the length of the trailer, and welding the receiver tube to the trailer.

18. The method according to claim 17,
step (f) including welding a cross member extending substantially perpendicular to the receiver tube to the trailer and the receiver tube.
